(19) United States
(12) Patent Application Publication
(10) Pub. No.: US 2025/0182594 A1
(43) Pub. Date: Jun. 5, 2025

(54) MONITORING DEVICE, MONITORING SYSTEM, AND METHOD

(71) Applicant: Toshiba Tec Kabushiki Kaisha, Tokyo (JP)

(72) Inventors: Keita YAMAZAKI, Mishima Shizuoka (JP); Yuishi TAKENO, Numazu Shizuoka (JP); Yusuke MIMURA, Sunto Shizuoka (JP)

(21) Appl. No.: 18/904,940

(22) Filed: Oct. 2, 2024

(30) Foreign Application Priority Data
Dec. 1, 2023 (JP) 2023-204056

(51) Int. Cl. G07G 3/00

(52) U.S. Cl. CPC G07G 3/003

(57) ABSTRACT

A monitoring device for identifying possible fraudulent actions at point-of-sale terminals includes a data storage unit, a communication interface, and a processor. The processor is configured to receive sensor output from at least one sensor associated with a point-of-sale terminal and determine, based on the received sensor output, whether merchandise is present in a bagging area after a registration of merchandise at the point-of-sale terminal. The processor is also configured to determine, based on the received sensor output, whether there is a person at the point-of-sale terminal and cause an output device to output a warning when it is determined, based on the received sensor output, that the person is at the point-of-sale terminal during an on-going transaction at the point-of-sale but registered merchandise is no longer present in the bagging area after its registration. The warning is output to the person at the point-of-sale terminal.

### CROSS-REFERENCE TO RELATED APPLICATION

This application is based upon and claims the benefit of priority from Japanese Patent Application No. 2023-204056, filed Dec. 1, 2023, the entire contents of which are incorporated herein by reference.

### FIELD

Embodiments described herein relate to a monitoring device, a monitoring system, and a method for monitoring retail transactions and the like.

### BACKGROUND

In recent years, there is an increasing number of stores in which self-service settlement terminals, often called a self-service POS terminal, are provided for a customer to register and pay for merchandise by himself or herself. That is, a shopper (customer) performs the checkout process of merchandise registration and making payment for the registered items without a store clerk or the like directly involved. Generally, with such a self-service POS terminal, a shopper scans a code symbol attached to the merchandise using a scanner to register the merchandise for purchase.

For self-service POS terminals, various techniques have been proposed to prevent fraud. For example, Reference JP2013-152634A proposes a technique in which a robotic face is caused to follow the movement of the merchandise being handled by a customer, thereby giving the customer an impression that the merchandise handling is being watched or monitored so as to limit or prevent the occurrence of fraud such as shoplifting. Reference JP2013-152634A also discloses that a store clerk, such as an attendant, may be notified when some kind of operational error or fraud is detected as occurring.

In actual practice and use of self-service terminals there may be scenarios where a husband carries away registered merchandise while his wife is still registering merchandise or performing a checkout (payment) operation at the self-service POS terminal. In such a case, merchandise that is not yet paid for may be carried away from the self-service terminal, but there is no mechanism to notify the person still at the self-service POS terminal that an improper removal of merchandise may have occurred.

### BRIEF DESCRIPTION OF THE DRAWINGS

FIG. 1 is a schematic configuration diagram of a settlement system incorporating a monitoring device according to a first embodiment.

FIG. 2 is a perspective view of a self-service POS terminal.

FIG. 3 is a block diagram of a self-service POS terminal.

FIG. 4 is a diagram showing an example of contents of a detection data memory.

FIG. 5 is a diagram showing an example of contents of a reference data storage unit.

FIG. 6 is a flowchart of information processing executed by a processor as a monitoring device.

FIG. 7 is a schematic diagram showing a warning display as an example of a warning output.

FIG. 8 is a schematic configuration diagram a settlement system incorporating a monitoring device according to a second embodiment.

FIG. 9 is a block diagram of a server device.

FIG. 10 is a diagram showing an example of a data configuration of a terminal reference data storage unit and a terminal detection data memory.

FIG. 11 is a sequence diagram showing operations of a settlement system.

FIG. 12 is a flowchart of information processing related to a monitoring operation executed by a processor of a self-service POS terminal.

FIG. 13 is a flowchart of information processing executed by a processor of a server device functioning as a monitoring device.

FIG. 14 is a schematic configuration diagram showing a settlement system incorporating a monitoring device according to a third embodiment.

FIG. 15 is a diagram showing a relationship between a self-service POS terminal and a monitoring camera.

FIG. 16 is a block diagram of a self-service POS terminal.

FIG. 17 is a flowchart of information processing executed by a processor of a self-service POS terminal functioning as a monitoring device.

### DETAILED DESCRIPTION

In general, according to one embodiment, a monitoring device, a monitoring system, and a method are provided for notifying a person performing a checkout operation when merchandise for which checkout has not yet been completed is improperly carried away from a self-service point-of-sales terminal. Such devices, systems, and methods represent an improvement to existing devices, systems, and methods related to retail sales transaction processing and the like since fewer false alarms or the like may result.

In one embodiment, a monitoring device includes a data storage unit, a communication interface, and a processor. The processor is configured to receive sensor output from at least one sensor associated with a point-of-sale terminal, determine, based on the received sensor output, whether merchandise is present in a bagging area after a registration of merchandise at the point-of-sale terminal, determine, based on the received sensor output, whether there is a person at the point-of-sale terminal, and cause an output device to output a warning when it is determined, based on the received sensor output, that the person is at the point-of-sale terminal during an on-going transaction at the point-of-sale but merchandise is no longer present in the bagging area after the registration of merchandise. The warning is output to the person at the point-of-sale terminal to indicate that merchandise has been removed from the bagging area before completion (payment) of the transaction. For example, a warning provided to a customer in such a case may be provided in lieu of alarm notification generally intended to indicate potential fraudulent actions by the customer. In various examples, the monitoring device may be integrated in the point-of-sale terminal or provided by an external server device or other external device.

Hereinafter, certain example embodiments of a monitoring device will be described with reference to the drawings.

### First Embodiment

In the first embodiment, a settlement system based on a self-service method will be described as an example.

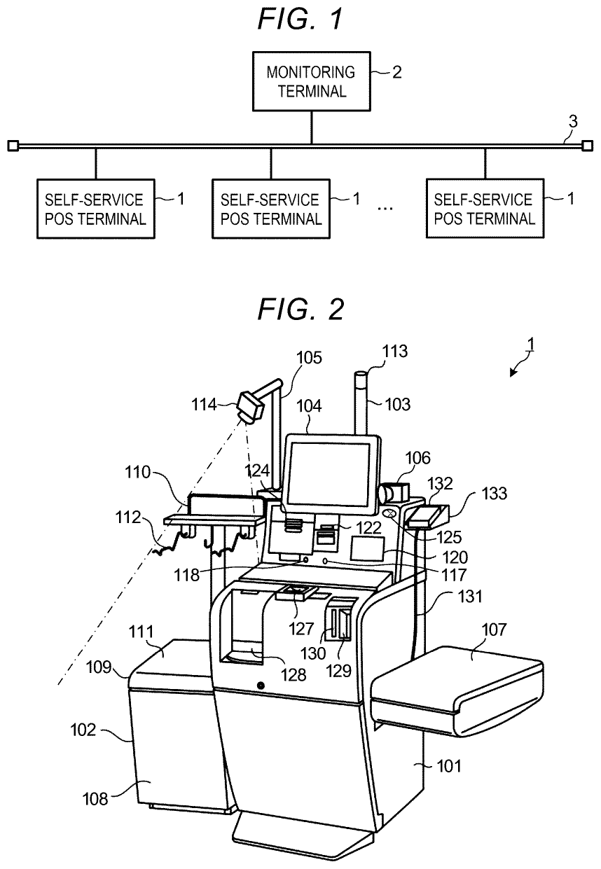

FIG. 1 depicts a settlement system incorporating a monitoring system according to a first embodiment. The settlement system in this example includes self-service POS terminals 1 to which a monitoring device according to the first embodiment is connected. The settlement system includes a plurality of self-service POS terminals 1 and a monitoring terminal 2. The settlement system connects each self-service POS terminal 1 to the monitoring terminal 2 via a communication network 3, such as a local area network (LAN). The monitoring terminal 2 is operated by a store clerk (an attendant) who monitors the self-service POS terminals 1 connected to the communication network 3.

The self-service POS terminals 1 are disposed in a checkout area of a store, and a shopper who has finished shopping in the sales area of the store and is ready for checkout is a user. Generally, a customer puts purchased merchandise in a shopping basket or the like while on the sales floor (sales area) on which merchandise is displayed and then moves to the checkout area to operate a self-service POS terminal 1 to perform settlement for the purchased merchandise. In this context, settlement is related to a transaction involving the registration of items (merchandise) for purchase then payment of the registered items all in a self-service process. The self-service POS terminal 1 can be a full-self-service settlement device at which items can be both registered and paid for by the customer. The settlement device may be referred to as a settlement terminal, a settling device, a settling terminal, a checkout device, a checkout terminal, a merchandise registration device, a merchandise registration terminal, or the like.

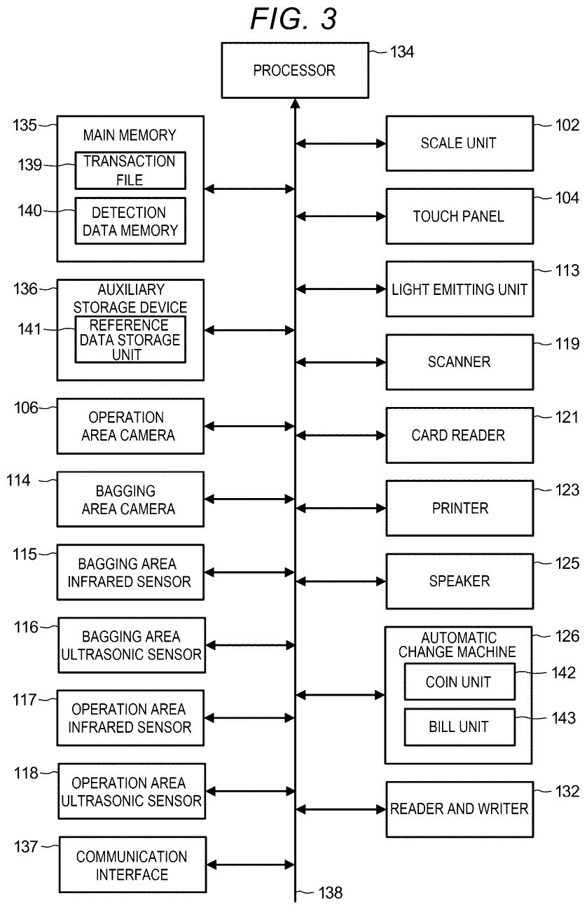

FIG. 2 is a perspective view showing an external configuration of a self-service POS terminal 1. FIG. 3 is a block diagram of the self-service POS terminal 1.

As shown in FIG. 2, the self-service POS terminal 1 includes a main body 101 disposed on a floor surface and a scale unit 102 disposed beside the main body 101. A display pole 103, a touch panel 104, a camera pole 105, and an operation area camera 106 are attached to an upper portion of the main body 101. The main body 101 has a basket table 107 on a central portion of a side surface opposite to the side on which the scale unit 102 is disposed. The basket table 107 is for a customer coming from a sales floor to place a basket or the like containing items to be purchased. The customer stands on a front side of the main body 101 in FIG. 2 so as to view a screen of the touch panel 104. Therefore, if viewed from the customer, the basket table 107 is on a right side and the scale unit 102 is on a left side with the main body 101 between. In the following description, the side on which the customer stands is called the front surface of the main body 101, the side on which the scale unit 102 is disposed is the left side of the main body 101, and the side on which the basket table 107 is provided is the right side of the main body 101.

The scale unit 102 has a structure in which a scale dish 109 is provided on an upper portion of a housing 108, and a bag holder 110 is attached to an upper portion of the scale dish 109. The scale dish 109 has as its upper surface a placement surface 111. The bag holder 110 includes a pair of holding arms 112. The holding arms 112 hold a store-provided shopping bag or a customer's reusable shopping bag. The scale unit 102 measures the weight of the merchandise put in the shopping bag or reusable shopping bag being held by the holding arms 112 or placed on the placement surface 111. The placement surface 111 is an example of a merchandise placement area. The scale unit 102 is an example of a weighing device that measures a weight of an object placed in the merchandise placement area.

The display pole 103 includes a light emitting unit 113 that selectively emits, for example, blue light and red light at a tip end portion thereof. The display pole 103 displays an operating state of the self-service POS terminal 1, for example, a standby state, an in-use state, a calling state, or an error state according to a color of a light emitted from the light emitting unit 113.

The touch panel 104 includes a display for displaying various screens to a user who operates the self-service POS terminal 1 and a touch sensor for detecting a touch input on the screen by the user. The user of the self-service POS terminal 1 is usually a shopper.

A bagging area camera 114 is attached to the camera pole 105. An attachment position and a posture of the bagging area camera 114 are set so that the placement surface 111 is within the camera's angle of view (image field), that is, an imaging area, as indicated by one-dot chain lines in FIG. 2. The bagging area camera 114 images the merchandise placement area. More specifically, the bagging area camera 114 is set so that the imaging area thereof can image the merchandise being placed into a shopping bag being held by the holding arm 112. The imaging area of the bagging area camera 114 may be referred to as a bagging area.

Additionally, a bagging area infrared sensor 115 (see FIG. 3) and a bagging area ultrasonic sensor 116 (see FIG. 3) are on the camera pole 105 face towards the bagging area. The bagging area infrared sensor 115 and the bagging area ultrasonic sensor 116 may be used to measure a distance to the placement surface 111 and/or a distance to merchandise placed on the placement surface 111 by using infrared or ultrasonic waves. The bagging area infrared sensor 115 and the bagging area ultrasonic sensor 116 are examples of a distance sensor that measures a distance to the merchandise placement area. The scale unit 102, the bagging area camera 114, the bagging area infrared sensor 115, and the bagging area ultrasonic sensor 116 are each examples of a sensor whose detection (monitoring) area covers the merchandise placement area.

The operation area camera 106 is set such that an imaging area thereof covers a region in front of the self-service POS terminal 1. Accordingly, the operation area camera 106 can image a customer standing in front of the self-service POS terminal 1. The imaging area of the operation area camera 106 may be referred to as an operation area or a user operating area.

An operation area infrared sensor 117, an operation area ultrasonic sensor 118, a reading window 120 of a scanner 119 (see FIG. 3), a card insertion slot 122 of a card reader 121 (see FIG. 3), an issuing port 124 of a receipt printed by a printer 123 (see FIG. 3), and a speaker 125 are on the front surface of the main body 101. The operation area infrared sensor 117 and the operation area ultrasonic sensor 118 are used as so called “human sensors” for detecting the presence of a customer standing in front of the self-service POS terminal 1, that is, the presence or absence of a customer in the user operation area. A coin inlet 127, a coin outlet 128, a bill inlet 129, and a bill outlet 130 for the automatic change machine 126 (see FIG. 3) are on the front surface of the main body 101.

A communication cable 131 extends from the right-side surface of the main body 101. A reader/writer 132 for reading (and writing) information from (to) an electronic money medium is connected to the communication cable 131. The reader/writer 132 is placed on a table 133 provided on an upper portion of a right-side surface of the main body 101.

As shown in FIG. 3, the self-service POS terminal 1 includes a processor 134, a main memory 135, an auxiliary storage device 136, a communication interface 137, and a system transmission path 138 in addition to the scale unit 102, the touch panel 104, the light emitting unit 113, the bagging area camera 114, the bagging area infrared sensor 115, the bagging area ultrasonic sensor 116, the operation area infrared sensor 117, the operation area ultrasonic sensor 118, the scanner 119, the card reader 121, the printer 123, the speaker 125, the automatic change machine 126, and the reader/writer 132. The system transmission path 138 can comprise an address bus, a data bus, a control signal line, and the like. The system transmission path 138 connects the processor 134 and other units directly or via a signal input and output (I/O) circuit, and carries data signals exchanged therebetween. In the self-service POS terminal 1 the processor 134 is connected to the main memory 135 and the auxiliary storage device 136 by the system transmission path 138. The self-service POS terminal 1 is an example of a monitoring device according to the first embodiment that controls a notification member provided corresponding to each of a plurality of action areas in which a plurality of actions in a series of actions executed by the shopper are performed.

The processor 134 controls various device units to implement the functions of the self-service POS terminal 1 in accordance with an operating system and/or an application program. The processor 134 is, for example, a central processing unit (CPU). The processor 134 may be, for example, a micro processing unit (MPU), a system on chip (SoC), a digital signal processor (DSP), a graphics processing unit (GPU), an application specific integrated circuit (ASIC), a programmable logic device (PLD), or a field-programmable gate array (FPGA). Alternatively, the processor 134 may be a combination of these.

The main memory 135 includes a non-volatile memory area and a volatile memory area. The main memory 135 stores an operating system and/or an application program in the non-volatile memory area. The main memory 135 may store data necessary for the processor 134 to execute a process for controlling each unit in the non-volatile or volatile memory area. The main memory 135 uses the volatile memory area as a work area in which data is appropriately rewritten by the processor 134. The non-volatile memory area is, for example, a read only memory (ROM). The volatile memory area is, for example, a random access memory (RAM). For example, the main memory 135 stores a transaction file 139 and a detection data memory 140.

The transaction file 139 is a data file for storing information related to each merchandise transaction processed by the self-service POS terminal 1. The transaction file 139 stores data such as a transaction number (e.g., transaction ID), purchased merchandise data, a total quantity, a total transaction amount, a discount amount, and a settlement amount. The transaction number can be a series of numbers issued each time a merchandise transaction is processed at the self-service POS terminal 1. The purchased merchandise data is an entry for each merchandise item purchased in the merchandise transaction. Here, the purchased merchandise data entry includes items such as a merchandise code, a merchandise name, a price, a quantity, and an amount of money paid. The transaction file 139 can store a plurality of pieces of purchased merchandise data for each transaction. In this context, total quantity is the total number of purchased merchandise involved in the transaction. The total transaction amount is a sum of money due (nominal price) for each item of purchased merchandise in the transaction. The discount amount reflects any discounts applied to the total transaction amount. The settlement amount is an amount obtained by subtracting the discount amount from the total transaction amount.

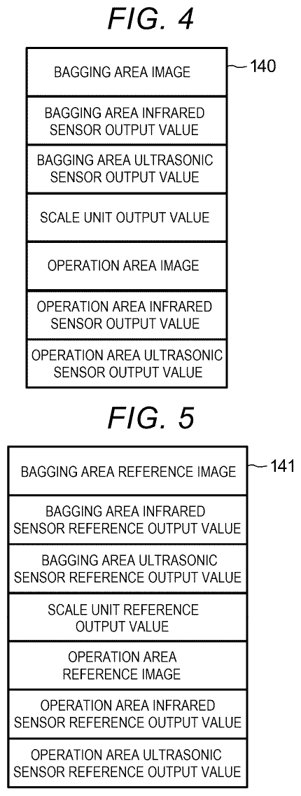

FIG. 4 is a diagram showing an example of storage contents of the detection data memory 140. As shown in FIG. 4, the detection data memory 140 stores a bagging area image, a bagging area infrared sensor output value, a bagging area ultrasonic sensor output value, a scale unit output value, an operation area image, an operation area infrared sensor output value, and an operation area ultrasonic sensor output value. In this context, the bagging area image is the latest (last) captured images output by the bagging area camera 114. Likewise, the bagging area infrared sensor output value is the latest output value of the bagging area infrared sensor 115; the bagging area ultrasonic sensor output value is the latest output value of the bagging area ultrasonic sensor 116; the scale unit output value is the latest output value of the scale unit 102; the operation area image is the latest image output from the operation area camera 106; the operation area infrared sensor output value is the latest output value of the operation area infrared sensor 117; and the operation area ultrasonic sensor output value is the latest output value of the operation area ultrasonic sensor 118.

For example, an electric erasable programmable read-only memory (EEPROM), a hard disk drive (HDD), or a solid-state drive (SSD) may serve as the auxiliary storage device 136. The auxiliary storage device 136 stores data used by the processor 134, data generated by the processor 134, and the like. For example, the auxiliary storage device 136 includes a reference data storage unit 141. The auxiliary storage device 136 may store the application program.

FIG. 5 is a diagram showing an example of storage contents of the reference data storage unit 141. As shown in FIG. 5, the reference data storage unit 141 stores a bagging area reference image, a bagging area infrared sensor reference output value, a bagging area ultrasonic sensor reference output value, a scale unit reference output value, an operation area reference image, an operation area infrared sensor reference output value, and an operation area ultrasonic sensor reference output value. The bagging area reference image corresponds to a captured image from the bagging area camera 114 when there is no merchandise on the placement surface 111. The bagging area infrared sensor reference output value is an output value of the bagging area infrared sensor 115 when there is no merchandise in the bagging area. Similarly, the bagging area ultrasonic sensor reference output value is an output value of the bagging area ultrasonic sensor 116 when there is no merchandise in the bagging area. The scale unit reference output value is an output value of the scale unit 102 when no merchandise is in the bagging area. The operation area reference image is a captured image from the operation area camera 106 when there is no person in front of the self-service POS terminal 1. The operation area infrared sensor reference output value is an output value of the operation area infrared sensor 117 when there is no person in front of the self-service POS terminal 1. The operation area ultrasonic sensor reference output value is an output value of the operation area ultrasonic sensor 118 when there is no person in front of the self-service POS terminal 1. The processor 134 acquires the outputs serving as a reference, in advance of a transaction processing, for example, when the self-service POS terminal 1 is first installed or the like. The processor 134 stores the reference outputs in the reference data storage unit 141.

Thus, the reference data storage unit 141 is an example of a storage unit that stores a reference output from a sensor acquired in advance when no merchandise is in the merchandise placement area. In some cases, reference output need not be acquired or provided for every possible sensor, however, generally, at least one of the bagging area camera 114, the bagging area infrared sensor 115, the bagging area ultrasonic sensor 116, and the scale unit 102 will have a corresponding reference output. The reference data storage unit 141 is an example of the storage unit that stores a reference output from a sensor. A reference output for certain sensors may be acquired whenever there is no person in front of the self-service POS terminal 1. In some cases, reference output need not be acquired or provided for every possible sensor, however, generally, at least one of the operation area camera 106, the operation area infrared sensor 117, and the operation area ultrasonic sensor 118 will have a corresponding reference output.

The communication interface 137 performs data communication with an external device connected via the communication network 3 according to a preset communication protocol. The external device is, for example, a monitoring terminal 2. The communication interface 137 is an example of a communication unit that communicates an external device.

The scanner 119 reads a code symbol from an item of merchandise held over or in front of the reading window 120. Generally, each item of merchandise sold in a store is given a code symbol in which a merchandise ID (commodity code) or the like for identifying the merchandise is encoded. The code symbol is, for example, a bar code. The code symbol may be, for example, a two-dimensional data code. The scanner 119 may be a type that reads a code symbol using a laser beam for scanning or may be a type that reads a code symbol from an image captured by an imaging device.

The card reader 121 reads card data recorded on a card medium such as a credit card or a point card (customer loyalty card). The card reader 121 draws a card medium inserted into the card insertion slot 122 into the main body 101, reads card data, and then ejects the card medium from the card insertion slot 122.

The printer 123 prints receipt data and the like representing details of a merchandise transaction on receipt paper. The receipt paper on which the receipt data is printed is ejected from the issuing port 124 and issued as a receipt.

The speaker 125 generates a voice message or a notification sound.

The automatic change machine 126 includes a coin unit 142 and a bill unit 143. The coin unit 142 sorts coins inserted into the coin inlet 127, identifies a denomination, and stores the coins in a safe (vault) according to the denomination. The coin unit 142 provides coins from the safe to make transaction change or the like and dispenses coins to the coin outlet 128. The bill unit 143 sorts bills inserted into the bill inlet 129, identifies a denomination, and stores the bills in a safe (vault) according to the denomination. The bill unit 143 provides bills from the safe to make transaction change or the like and dispenses bills to the bill outlet 130.

The reader/writer 132 reads and writes data associated with electronic money from and to an electronic money medium. The electronic money medium is, for example, a non-contact IC card. In some examples, the electronic money medium may be an electronic device such as a smartphone or a tablet terminal.

Hereinafter, certain operations of the self-service POS terminal 1 will be described.

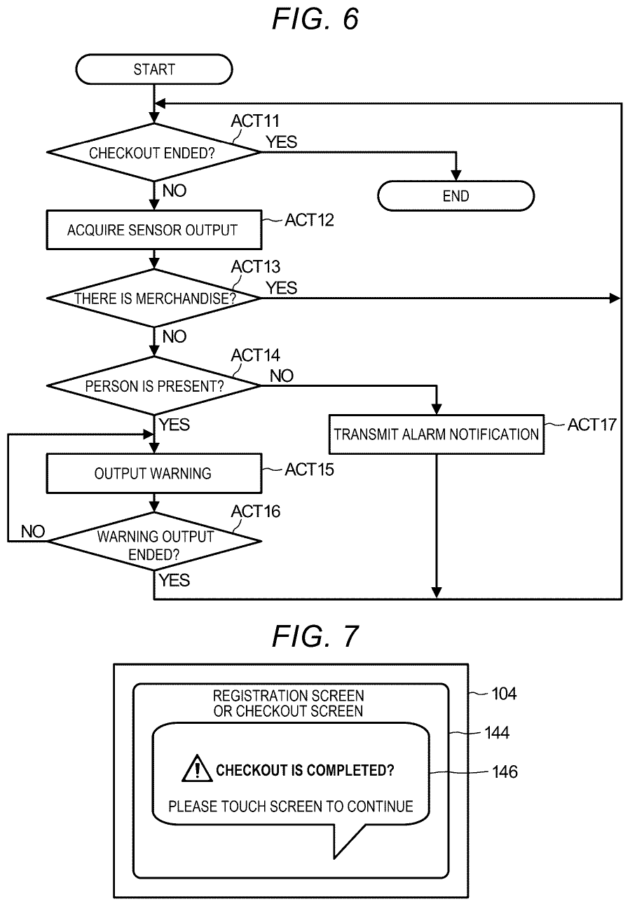

FIG. 6 is a flowchart showing an example of a procedure of an information processing executed by the processor 134 of the self-service POS terminal 1 functioning as a monitoring device according to the first embodiment. The procedure shown in FIG. 6 is an example and procedures are not particularly limited to this example as long as a similar result can be obtained.

The processor 134 waits for start of an operation by a shopper after the self-service POS terminal 1 has been powered on. For example, when the touch panel 104 is touched by the shopper, the processor 134 executes a registration and checkout of merchandise. In parallel with the registration and the checkout, the processor 134 also starts the procedure shown in FIG. 6, which is a process as a monitoring device. As described above, data is stored in advance in the reference data storage unit 141 before the start of the transaction.

In ACT 11, the processor 134 determines whether the checkout process at the self-service POS terminal 1 is ended. If the checkout is not yet ended, the processor 134 determines NO in ACT 11 and proceeds to ACT 12. If the checkout has ended, the processor 134 determines YES in ACT 11 and ends its processing as a monitoring device.

In ACT 12, the processor 134 acquires a sensor output. Specifically, the processor 134 acquires a captured image from the bagging area camera 114, an output value of the bagging area infrared sensor 115, an output value of the bagging area ultrasonic sensor 116, an output value of the scale unit 102, a captured image from the operation area camera 106, an output value of the operation area infrared sensor 117, and an output value of the operation area ultrasonic sensor 118, and stores the captured images and output values in the detection data memory 140.

In ACT 13, the processor 134 determines whether there is merchandise in the merchandise placement area. Specifically, the processor 134 determines the presence or of absence merchandise by comparing outputs of the bagging area camera 114, the bagging area infrared sensor 115, the bagging area ultrasonic sensor 116, and the scale unit 102 stored in the detection data memory 140 with reference outputs thereof already stored in the reference data storage unit 141. The processor 134 that executes the process of ACT 13 is an example of a merchandise determination unit that determines whether there is merchandise in the merchandise placement area. If there is merchandise, the processor 134 determines YES in ACT 13 and returns to ACT 11. If there is no merchandise, the processor 134 determines NO in ACT 13 and proceeds to ACT 14.

If the output of the bagging area camera 114 is used for the determination of the presence or absence of merchandise, a known image processing technique can be used for this purpose. For example, the processor 134 calculates HOG (histogram of oriented gradients) feature data based on a bagging area image stored in the detection data memory 140 and a bagging area reference image stored in the reference data storage unit 141, and thus recognizes whether there is merchandise present based on whether a Euclidean distance of the calculated HOG feature data exceeds a threshold value.

If an output of the bagging area infrared sensor 115 or the bagging area ultrasonic sensor 116 is used, the processor 134 recognizes whether there is merchandise present based on whether a distance indicated by an output value stored in the detection data memory 140 has changed by a preset threshold value or more from a distance indicated by a reference output value stored in the reference data storage unit 141.

If an output of the scale unit 102 is used, the processor 134 recognizes whether there is merchandise present based on whether a weight stored in the detection data memory 140 is changed by a preset threshold value or more from a reference weight stored in the reference data storage unit 141.

In ACT 14, the processor 134 determines whether a person is present in front of the self-service POS terminal 1. Specifically, the processor 134 determines whether a person is present by comparing outputs of the operation area camera 106, the operation area infrared sensor 117, and the operation area ultrasonic sensor 118 stored in the detection data memory 140 to the reference outputs thereof already stored in the reference data storage unit 141. The processor 134 that executes the process in ACT 14 is an example of a person determination unit that determines whether there is a person in a user operation area associated with the merchandise placement area. If a person is present, the processor 134 determines YES in ACT 14 and proceeds to ACT 15. If there is no person present, the processor 134 determines NO in ACT 14 and proceeds to ACT 17.

If the output of the operation area camera 106 is used in determining whether a person is present, a known image processing technique can be used for this purpose. For example, the processor 134 calculates HOG feature data based on an operation area image stored in the detection data memory 140 and an operation area reference image stored in the reference data storage unit 141, and recognizes whether a person is present based on whether a Euclidean distance of the calculated HOG feature data exceeds a threshold value.

If an output of the operation area infrared sensor 117 or the operation area ultrasonic sensor 118 is used, the processor 134 recognizes whether a person is present based on whether a distance indicated by an output value stored in the detection data memory 140 is changed by a preset threshold value or more from a distance indicated by a reference output value stored in the reference data storage unit 141.

In ACT 15, the processor 134 outputs a warning. Specifically, the processor 134 displays a warning on a display of the touch panel 104 or causes the speaker 125 to output a warning sound or a warning voice. The processor 134 that executes the process of ACT 15 is an example of a warning unit that causes an output unit to output a notice/warning when the merchandise determination unit determines that there is no longer merchandise in the merchandise placement area but the person determination unit determines that there is the person still present at self-service POS terminal 1 and the checkout of the purchased merchandise has not yet ended. The display of the touch panel 104 and the speaker 125 are examples of an output device in this context.

FIG. 7 is a schematic diagram showing a warning display as an example of a warning output in this context. As shown in FIG. 7, while a registration screen or a checkout screen 144 is still being displayed on the display of the touch panel 104, a predetermined warning display 146 is superimposed and/or displayed as a pop-up window. The predetermined warning display may include text such as “Checkout is completed?” when the checkout has not ended yet.

In ACT 16, the processor 134 determines whether to end the warning output. For example, the processor 134 can determine to end the warning output based on whether a touch operation is performed on the touch panel 104. If the warning output is not to be ended yet, the processor 134 determines NO in ACT 16 and returns to ACT 15. If the warning output is to be ended, the processor 134 determines YES in ACT 16 and returns to ACT 11.

In ACT 17, the processor 134 transmits an alarm notification from the communication interface 137 to a monitoring terminal 2 via the communication network 3. The alarm notification may include identification information such as a device number for specifying the self-service POS terminal 1. Upon receiving the alarm notification, the monitoring terminal 2 can output a notification that there may have been a fraud event of carrying away merchandise without checkout. The processor 134 that executes the process of ACT 17 is an example of an alarm unit that transmits an alarm notification to the host device through the communication unit to indicate the merchandise determination unit determined that there is no longer merchandise in the merchandise placement area and the person determination unit has determined that there is no person at the self-service POS terminal 1 while the checkout of the purchased merchandise was not correctly ended. Thereafter, the processor 134 returns to ACT 11.

As described above, the self-service POS terminal 1 functions as the monitoring device according to the first embodiment and outputs a warning on the touch panel 104 or the speaker 125 if there is no merchandise in the merchandise placement area of the self-service POS terminal 1 before the checkout process of the merchandise has ended. Accordingly, the processor 134 constitutes a merchandise determination unit that determines whether there is purchased merchandise in the merchandise placement area, a person determination unit that determines whether there is a person still in an operation area, and a warning unit that causes the output device to output warning information if the merchandise determination unit determines that there is no purchased merchandise but the person determination unit determines that there is the person still at the self-service POS terminal 1 and checkout is not yet completed,.

As described above, the self-service POS terminal 1 in the first embodiment outputs warning information to the person in front of the self-service POS terminal 1 if the purchased merchandise is about to be carried away before checkout is completed or ended. Thus, according to the self-service POS terminal 1 in the first embodiment, if merchandise that is not yet paid is carried away, it is possible to notify the person performing a checkout operation at the self-service POS terminal 1 of this situation.

The self-service POS terminal 1 ends the warning display after a touch operation is performed on the touch panel 104.

Accordingly, the shopper can continue to execute registration and checkout of the purchased merchandise.

The self-service POS terminal 1 includes the communication interface 137 that communicates with the monitoring terminal 2. The self-service POS terminal 1 transmits an alarm notification to the monitoring terminal 2 through the communication interface 137 when there is no purchased merchandise and no person when the checkout of the purchased merchandise still has not ended. Accordingly, the processor 134 functions as an alarm unit that transmits an alarm notification to the host device through the communication unit if the both the person and the merchandise leaves the self-service POS terminal 1 before checkout is completed.

Thus, in the first embodiment, if merchandise has been carried away and there is no person still at the self-service terminal 1 paying for it, it is determined that fraud may have occurred, and an alarm can be raised. In other words, the self-service POS terminal 1 in the first embodiment does not determine that fraud occurs and does not raise an alarm if there is still a person at the self-service terminal 1, even if merchandise in the transaction has been carried away. Thus, with the first embodiment, the occurrence of an erroneous alarm can be avoided.

The self-service POS terminal 1 includes sensors whose detection area covers the merchandise placement area, such as the scale unit 102, the bagging area camera 114, the bagging area infrared sensor 115, and the bagging area ultrasonic sensor 116, and the reference data storage unit 141. The reference data storage unit 141 stores the output of these sensors acquired in advance when no merchandise is in the merchandise placement area as reference output values (reference output). The self-service POS terminal 1 compares the current output of the sensor to the reference output for the sensor stored in the reference data storage unit 141 to determine whether there is purchased merchandise in the merchandise placement area.

Thus, the self-service POS terminal 1 in the first embodiment can easily identify the presence or absence of purchased merchandise.

### Second Embodiment

Next, a second embodiment will be described. Aspects similar to those of the first embodiment are denoted by the same reference symbols as those of the first embodiment, and description thereof may be omitted.

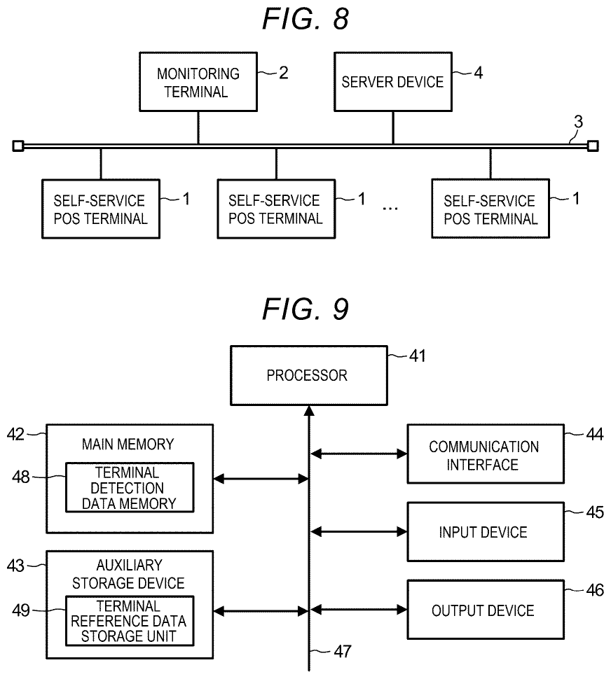

FIG. 8 is a schematic configuration diagram showing a settlement system incorporating a monitoring system according to the second embodiment. In the second embodiment, a server device 4 functions as a monitoring device. As shown in FIG. 8, in this settlement system, a plurality of self-service POS terminals 1, a monitoring terminal 2, and a server device 4 providing functions of a monitoring device according to the second embodiment are communicably connected via the communication network 3.

FIG. 9 is a block diagram of a server device 4 incorporating or providing a monitoring device according to a second embodiment. As shown in FIG. 9, the server device 4 includes a processor 41, a main memory 42, an auxiliary storage device 43, a communication interface 44, an input device 45, an output device 46, and a system transmission path 47. The system transmission path 47 comprises an address bus, a data bus, a control signal line, and the like. The system transmission path 47 connects the processor 41 and other units directly or via a signal input and output (I/O) circuit, and carries data signals exchanged therebetween. In the server device 4 the processor 41 is connected to the main memory 42 and the auxiliary storage device 43 by the system transmission path 47. The server device 4 is an example of a monitoring device according to the second embodiment that monitors shopper fraud at multiple self-service POS terminals 1.

The processor 41 controls various device units to implement the functions of the monitoring device according to the second embodiment in accordance with an operating system and/or an application program. The processor 41 may be, for example, a CPU, an MPU, an SoC, a DSP, a GPU, an ASIC, a PLD, or an FPGA. Alternatively, the processor 41 may be a combination of these.

The main memory 42 includes a non-volatile memory area and a volatile memory area. The main memory 42 stores an operating system and/or an application program in the non-volatile memory area. The main memory 42 may store data necessary for the processor 41 to execute a process for controlling each unit in the non-volatile or volatile memory area. The main memory 42 uses the volatile memory area as a work area in which data is appropriately rewritten by the processor 41. The non-volatile memory area is, for example, a ROM. The volatile memory area is, for example, a RAM. For example, the main memory 42 stores a terminal detection data memory 48.

For example, the auxiliary storage device 43 may be an EEPROM, an HDD, or an SSD. The auxiliary storage device 43 stores data used by the processor 41 executing various processes, data generated by a process in the processor 41, and the like. For example, the auxiliary storage device 43 includes a terminal reference data storage unit 49. The auxiliary storage device 43 may store the application program.

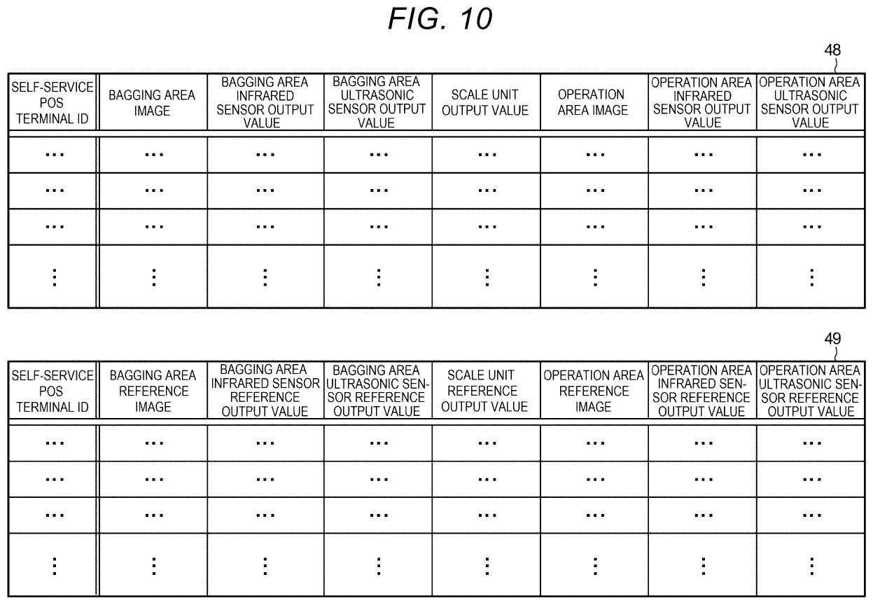

FIG. 10 is a diagram showing an example of storage contents of the terminal detection data memory 48 and the terminal reference data storage unit 49. As shown in FIG. 10, the terminal detection data memory 48 stores, in association with a self-service POS terminal ID (e.g., a device number uniquely identifying each of the plurality of self-service POS terminals 1), a bagging area image, a bagging area infrared sensor output value, a bagging area ultrasonic sensor output value, a scale unit output value, an operation area image, an operation area infrared sensor output value, and an operation area ultrasonic sensor output value similar to those described for the first embodiment. The terminal detection data memory 48 can be a database that stores contents of the detection data memory 140 (as shown in FIG. 4) for each self-service POS terminal 1 as a record associated with the corresponding self-service POS terminal ID of each self-service POS terminal 1. Similar to before, each output stored in the terminal detection data memory 48 is the latest one of the sensor outputs transmitted from the self-service POS terminal 1.

Similarly, the terminal reference data storage unit 49 stores, in association with each self-service POS terminal ID, a bagging area reference image, a bagging area infrared sensor reference output value, a bagging area ultrasonic sensor reference output value, a scale unit reference output value, an operation area reference image, an operation area infrared sensor reference output value, and an operation area ultrasonic sensor reference output value similar to those described for the first embodiment. That is, the terminal reference data storage unit 49 is a database that stores contents of the reference data storage unit 141 (shown in FIG. 5) of each of the self-service POS terminals 1 as a record associated with the corresponding self-service POS terminal IDs.

Since an output of a sensor of the self-service POS terminal 1 is stored in the server device 4, the self-service POS terminal 1 may not need to separately include the detection data memory 140 and the reference data storage unit 141 as in the first embodiment.

The communication interface 44 performs data communication with an device connected via the external communication network 3 according to a preset communication protocol. The external device is, for example, a self-service POS terminal 1 or a monitoring terminal 2.

The input device 45 is a user interface device such as a keyboard and a pointing device such as a mouse. The output device 46 is a user interface device such as a liquid crystal display. In some examples, the server device 4 does not need to include the input device 45 or the output device 46. That is, the input device 45 and/or the output device 46 can be provided outside the server device 4 such as by a management terminal connected to the communication network 3. In this case, the processor 41 can use the input device 45 and/or the output device 46 via the communication network 3 through the communication interface 44.

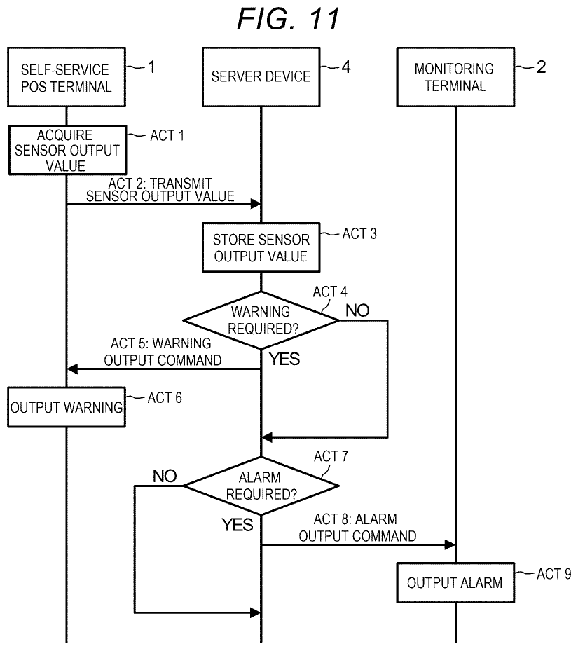

FIG. 11 is a sequence diagram showing an operation of the settlement system including a server device 4.

As shown in FIG. 11, each self-service POS terminal 1 acquires a sensor output (ACT 1). ACT 1 is similar to ACT 12 described in the first embodiment. The self-service POS terminal 1 transmits the acquired sensor output to the server device 4 (ACT 2).

The server device 4 receives the sensor output from the self-service POS terminal 1 and then stores the sensor output (ACT 3). The server device 4 compares the stored sensor output to a reference sensor output stored in advance to determine the presence or absence of merchandise in the merchandise placement area, thereby determining whether a warning is required (ACT 4). If a warning is required, the server device 4 transmits a warning output command (ACT 5) to the corresponding self-service POS terminal 1 instructing the self-service POS terminal 1 to output a warning.

The self-service POS terminal 1 receives the warning output command then outputs a warning (ACT 6).

The server device 4 next determines whether an alarm is required (ACT 7). This determination can be made by comparing a stored sensor output to a reference sensor output and determining the presence or absence of both merchandise and a person. If an alarm is required, the server device 4 transmits an alarm output command to the monitoring terminal 2 instructing the monitoring terminal 2 to output an alarm (ACT 8).

The monitoring terminal 2 that receives the alarm output command outputs an alarm (ACT 9).

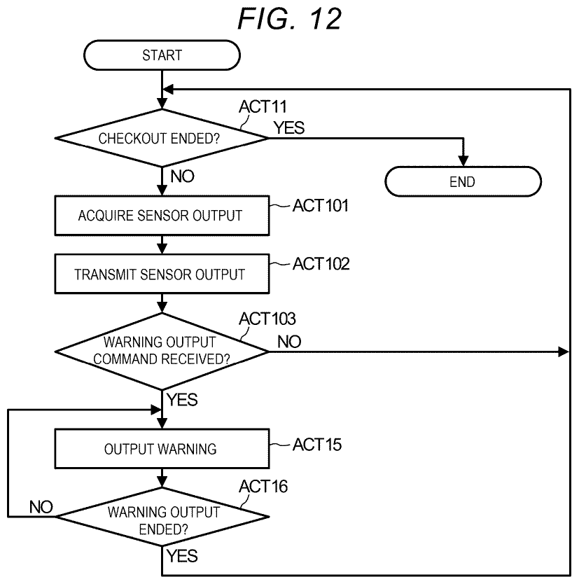

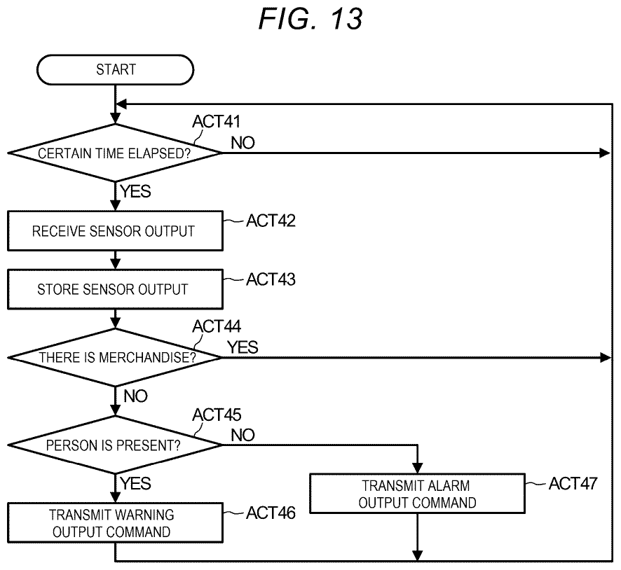

Next, a specific example of an operation of a monitoring device incorporated in or provided by the server device 4 will be described. FIG. 12 is a flowchart showing an example of a procedure of an information processing related to a monitoring operation executed by the processor 134 of a self-service POS terminal 1 in the second embodiment. FIG. 13 is a flowchart showing an example of a procedure of an information processing executed by the processor 41, as the monitoring device, of the server device 4 in the second embodiment.

As in the first embodiment, the processor 134 of the self-service POS terminal 1 starts the procedure shown in FIG. 12 in parallel with registration and checkout processing. At this start, data has already been stored in the terminal reference data storage unit 49 of the server device 4 for the self-service POS terminal 1.

As shown in FIG. 12, the processor 134 of the self-service POS terminal 1 checks, in ACT 11, whether the checkout has ended. If the checkout is not yet ended, the processor 134 determines NO in ACT 11 and proceeds to ACT 101. If the checkout has ended, the processor 134 determines YES in ACT 11 and ends the process.

In ACT 101, the processor 134 acquires a sensor output. Specifically, the processor 134 acquires a captured image from the bagging area camera 114, an output value of the bagging area infrared sensor 115, an output value of the bagging area ultrasonic sensor 116, an output value of the scale unit 102, a captured image from the operation area camera 106, an output value of the operation area infrared sensor 117, and/or an output value of the operation area ultrasonic sensor 118.

In ACT 102, the processor 134 transmits the acquired sensor output to the server device 4 via the communication network 3 through the communication interface 137. At this time, the processor 134 also transmits a self-service POS terminal ID, which is specific information for identifying a transmission source of the sensor output, together with the sensor output. If the sensor output is transmitted checkout has not yet ended at the self-service POS terminal 1.

The processor 41 of the server device 4 starts a processing procedure shown in FIG. 13 in response to some predetermined input by the input device 45 or otherwise, in ACT 41. For example, the processor 41 determines whether a predetermined certain time elapses in ACT 41. If the certain time has not yet elapsed, the processor 41 determines NO in ACT 41 and repeats ACT 41. In this way, the processor 41 waits for a certain time to elapse. Once the certain time elapses, the processor 41 determines YES in ACT 41 and proceeds to ACT 42.

In ACT 42, the processor 41 receives a sensor output transmitted from the self-service POS terminal 1 via the communication network 3 through the communication interface 44. The sensor output is not transmitted from a self-service POS terminal 1 is not presently executing the processing procedure shown in FIG. 12 in parallel with registration and the checkout processing. In other words, if the sensor output is received at the server device 4, the self-service POS terminal 1 that sent the sensor output is in a state in which the checkout is not yet ended (completed).

In ACT 43, the processor 41 stores the received sensor output. Specifically, the processor 41 specifies a corresponding record in the terminal detection data memory 48 in which the sensor output is to be stored based on the self-service POS terminal ID transmitted together with the sensor output, and stores the received self-service output in the appropriate record for the self-service POS terminal 1. The sensor output that is not the latest of the same type for the same self-service POS terminal 1 is deleted. Instead of deleting the sensor output that is not the latest, the received sensor output can be stored in association with a reception time (time stamp) or the like to permit a determination of whether stored sensor output is the latest (most recent) sensor output.

In ACT 44, the processor 41 determines whether there is any merchandise in the merchandise placement area of a self-service POS terminal 1. Specifically, the processor 41 determines presence or absence of the merchandise for each self-service POS terminal 1 by comparing the latest sensor output (e.g., the bagging area image, the bagging area infrared sensor output value, the bagging area ultrasonic sensor output value, and/or the scale unit output value) stored in the corresponding record of the terminal detection data memory 48 to reference output(s) stored in advance in the terminal reference data storage unit 49. The processor 41 that executes the process of ACT 44 is an example of a merchandise determination unit that determines whether there is merchandise in the merchandise placement area based on an output of a sensor transmitted from a settlement device. If there is merchandise at a self-service POS terminal 1, the processor 41 determines YES in ACT 44 and returns to ACT 41. If there is no merchandise at the self-service POS terminal 1, the processor 41 determines NO in ACT 44 and proceeds to ACT 45.

In ACT 45, the processor 41 determines whether a person is present in front of the self-service POS terminal 1 at which no merchandise was present in the merchandise placement area. Specifically, the processor 134 determines whether a person is present by comparing an operation area image, an operation area infrared sensor output value, and/or an operation area ultrasonic sensor output value stored in the terminal detection data memory 48 to reference outputs thereof stored in the terminal reference data storage unit 49. Regarding a self-service POS terminal 1 where a person is present, the processor 134 determines YES in ACT 45 and proceeds to ACT 46. Regarding the self-service POS terminal 1 where no person is present, the processor 134 determines NO in ACT 46 and proceeds to ACT 47.

In ACT 46, the processor 41 transmits a warning output command through the communication interface 44 via the communication network 3 to the self-service POS terminal 1 where there is no merchandise but a person is still present. Thereafter, the processor 41 returns to ACT 41.

Referring back to FIG. 12. As shown in FIG. 12, the processor 134 of the self-service POS terminal 1 that transmits sensor output in ACT 102 determines whether a warning output command is received via the communication interface 137 from the server device 4. If a warning output command is not received, the processor 134 determines NO in ACT 103 and returns to ACT 11. If the warning output command is received, the processor 134 determines YES in ACT 103 and proceeds to ACT 15.

In ACT 15, the processor 134 outputs a warning as described in the first embodiment.

In ACT 16, the processor 134 determines whether to end the warning output. If the warning output is not ended, the processor 134 determines NO in ACT 16 and returns to ACT 15. If the warning output is ended, the processor 134 determines YES in ACT 16 and returns to ACT 11.

Referring back to FIG. 13, the processor 41 of the server device 4 that determines that there is no merchandise and no person is present in ACT 45 transmits an alarm output command to the monitoring terminal 2 via the communication network 3 through the communication interface 44 in ACT 47. The alarm output command may include a self-service POS terminal ID for specifying the corresponding self-service POS terminal 1 in order to indicate which self-service POS terminal 1 at which the possible fraud event occurred. Upon receiving the alarm output command, the monitoring terminal 2 can output a notification that there was fraud event of carrying away merchandise without completing checkout. In addition to the command transmission, the processor 41 may output an alarm to an administrator of the server device 4 through the output device 46. Thereafter, the processor 41 proceeds to ACT 41.

As described above, the processor 41 in the server device 4 can be considered to be the monitoring device according to the second embodiment, and if it is determined that there is no purchased merchandise in the merchandise placement area based on sensor output transmitted from the self-service POS terminal 1 when checkout at the self-service POS terminal 1 is not ended, a warning output command is transmitted to the self-service POS terminal 1 and this causes the self-service POS terminal 1 to output a warning. Accordingly, the processor 41 provides a merchandise determination unit that identifies whether there is purchased merchandise in the merchandise placement area based on the sensor output transmitted from the settlement device (self-service POS terminal 1) and a transmission unit that transmits a warning output command to the settlement device (self-service POS terminal 1) if the merchandise determination unit determines that there is no purchased merchandise in the placement area when the checkout of purchased merchandise at the settlement device (self-service POS terminal 1) has not yet been ended.

Thus, in the second embodiment, a similar effect as that of the first embodiment can be obtained.

### Third Embodiment

Next, a third embodiment will be described. Aspects similar to those of the first embodiment are denoted by the same reference symbols as those of the first embodiment, and description thereof may be omitted.

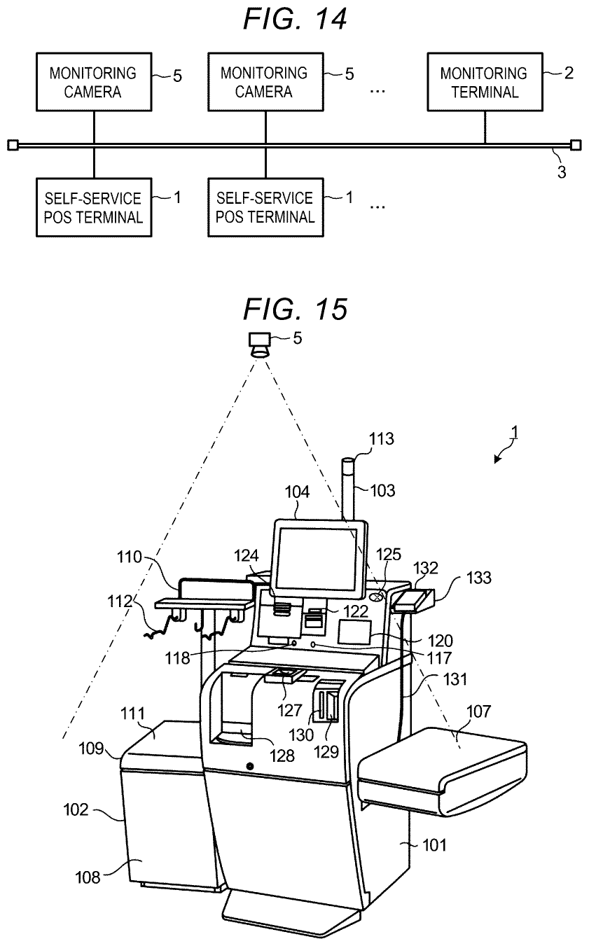

FIG. 14 is a schematic configuration diagram showing a settlement system including self-service POS terminals 1 incorporating a monitoring device according to the third embodiment. As shown in FIG. 14, a plurality of self-service POS terminals 1, a monitoring terminal 2, and a plurality of monitoring cameras 5 are communicably connected via the communication network 3. Although the monitoring camera 5 is depicted as a dedicated system camera, if a security camera is already disposed on a ceiling or the like, a security camera may be used as a monitoring camera 5.

FIG. 15 is a diagram showing a relationship between a self-service POS terminal 1 and a monitoring camera 5. In the third embodiment, instead of an operation area camera 106 and a bagging area camera 114 as in the first embodiment, one monitoring camera 5 is disposed corresponding to each self-service POS terminal 1. The monitoring camera 5 is disposed, for example, by being embedded in or suspended from the ceiling so as to cover the imaging areas matching or encompassing those of the operation area camera 106 and the bagging area camera 114. As in the first embodiment, a camera pole 105 may be provided on the self-service POS terminal 1, and the monitoring camera 5 may be disposed on the camera pole 104. The monitoring camera 5 is an example of a camera that images both the merchandise placement area and the operation area.

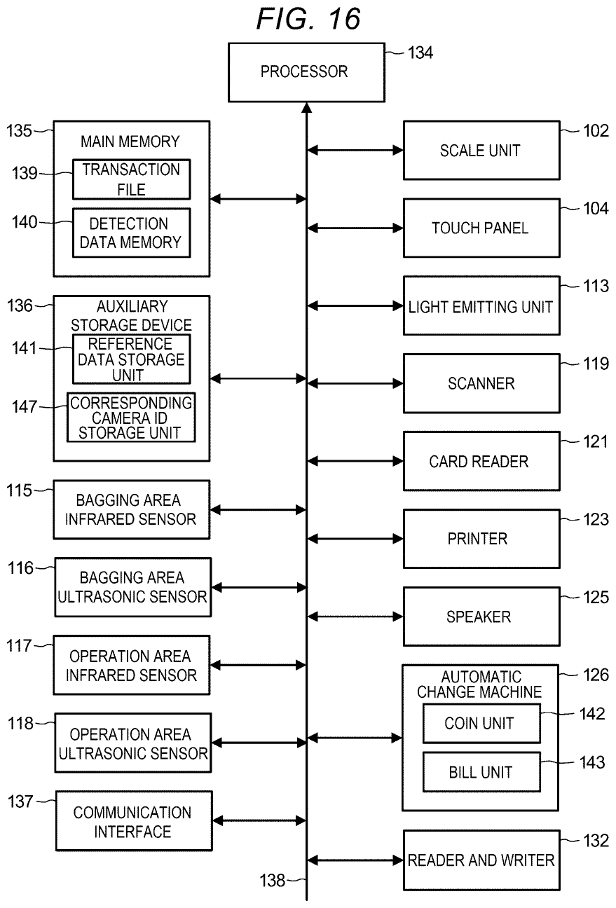

FIG. 16 is a block diagram of a self-service POS terminal 1. In this third embodiment, the auxiliary storage device 136 further includes a corresponding camera ID storage unit 147. The corresponding camera ID storage unit 147 stores a camera ID (such as a device number) for uniquely identifying each monitoring camera 5 provided corresponding to a self-service POS terminal 1. The processor 134 can specify, based on the camera ID stored in the corresponding camera ID storage unit 147, the particular monitoring camera 5 corresponding to a self-service POS terminal 1 from among the plurality of monitoring cameras 5 connected to the communication network 3.

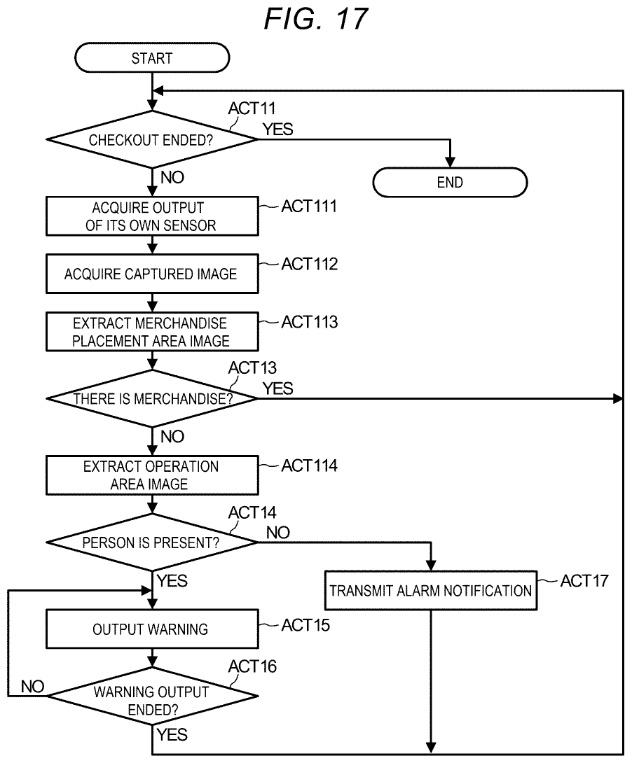

FIG. 17 is a flowchart showing an example of a procedure of an information processing executed by the processor 134 of the self-service POS terminal 1 as a monitoring device in the third embodiment. In the present embodiment, if it is determined that the checkout is not ended in ACT 11, the processor 134 acquires its own sensor output in ACT 111. Specifically, the processor 134 acquires output values from the bagging area infrared sensor 115, the bagging area ultrasonic sensor 116, the scale unit 102, the operation area infrared sensor 117, and the operation area ultrasonic sensor 118, and stores the output values in the detection data memory 140.

In ACT 112, the processor 134 acquires a captured image from the monitoring camera 5. Specifically, the processor 134 acquires a captured image from the monitoring camera 5 corresponding to the particular self-service POS terminal 1 via the communication network 3 through the communication interface 137 based on the camera ID stored in the corresponding camera ID storage unit 147. The processor 134 stores the acquired captured image in a work area of its associated main memory.

In ACT 113, the processor 134 extracts a merchandise placement area image from the acquired captured image. In general, the positional relationship between the self-service POS terminal 1 and the corresponding monitoring camera 5 is fixed. Accordingly, the processor 134 can know in advance which pixels in an image captured by the monitoring camera 5 will correspond to the merchandise placement area and which pixels will correspond to the user operation area. Accordingly, the processor 134 can easily extract, that is, cut out a merchandise placement area image from the acquired captured image. The processor 134 stores the extracted merchandise placement area image in the detection data memory 140 as a bagging area image.

In ACT 13, as described in the first embodiment, the processor 134 compares the sensor output stored in the detection data memory 140 with the reference output stored in the reference data storage unit 141 to determine the presence or absence of merchandise in the merchandise placement area. If there is merchandise, the processor 134 determines YES in ACT 13 and returns to ACT 11. If there is no merchandise, the processor 134 determines NO in ACT 13 and proceeds to ACT 114.

In ACT 114, the processor 134 extracts an operation area image from the captured image stored in the work area of the main memory 135. Similarly to the merchandise placement area image, the processor 134 can easily extract, that is, cut out an operation area image from the captured image. The processor 134 stores the extracted operation area image in the detection data memory 140. In this third embodiment, the operation area can be an area within a certain region or within a certain distance from the main body 101 on the front side of the self-service POS terminal 1.

Thereafter, the processor 134 proceeds to ACT 14. The subsequent ACT 14 to ACT 17 are as described for the first embodiment.

As described above, the self-service POS terminal 1 provides the functions of a monitoring device in the third embodiment, extracts a merchandise placement area image from an image captured by the monitoring camera 5 (that images both the merchandise placement area and the operation area) to determine presence or absence of merchandise and also extracts an operation area image from the captured image by the monitoring camera 5 to determine whether there is a person at (or near) the self-service POS terminal 1.

Thus, in the third embodiment, similar effects as that of the first embodiment can be obtained.

The third embodiment can be similarly applied to the second embodiment in other examples.

### Other Embodiments

Although certain examples of a monitoring device are described above, the present disclosure is not limited thereto.

For example, while in the second embodiment a server device 4 is separately provided, a function of the server device 4 may instead be incorporated in the monitoring terminal 2. That is, a monitoring device according to the second embodiment may be incorporated in the monitoring terminal 2 instead of a server device 4. In some examples, the server device 4 may be implemented as a cloud-based server device disposed outside the store.

In the third embodiment, the self-service POS terminal 1 and the monitoring camera 5 are provided in a one-to-one relationship, but one monitoring camera 5 may be capable of capturing images for multiple self-service POS terminals 1.

In each described embodiment, a self-service POS terminal 1 may have a greater or lesser number of sensors than the described examples.

While several embodiments have been described, these embodiments have been presented by way of example only and are not intended to limit the scope of the present disclosure. Indeed, these novel embodiments can be implemented in various other forms, and various omissions, substitutions, and modifications can be made without departing from the gist and scope of the present disclosure. These embodiments and modifications thereof are included in the scope of the present disclosure and reflected in the accompanying claims and equivalents thereof.

What is claimed is:

1. A monitoring device, comprising:
a data storage unit;
a communication interface; and
a processor configured to:
receive sensor output from at least one sensor associated with a point-of-sale terminal;
determine, based on the received sensor output, whether merchandise is present in a bagging area after a registration of merchandise at the point-of-sale terminal;
determine, based on the received sensor output, whether there is a person at the point-of-sale terminal; and
cause an output device to output a warning when it is determined, based on the received sensor output, that the person is at the point-of-sale terminal during an on-going transaction at the point-of-sale but merchandise is no longer present in the bagging area after the registration of merchandise, wherein
the warning is output to the person at the point-of-sale terminal.

2. The monitoring device according to claim 1, further comprising:
a communication interface configured to communicate with an external device, wherein
the processor is further configured to:
cause an alarm notification to be output via the communication interface to the external device when it is determined, based on the received sensor output, that the person is not at the point-of-sale terminal during an on-going transaction at the point-of-sale and merchandise is no longer present in the bagging area after the registration of merchandise.

3. The monitoring device according to claim 1, wherein
the data storage unit stores a reference output for the at least one sensor, and
the processor determines whether merchandise is present in the bagging area by comparing the received sensor output to the stored reference output.

4. The monitoring device according to claim 1, wherein
the data storage unit stores a reference output for the at least one sensor, and
the processor determines whether the person is at the point-of-sale terminal by comparing the received sensor output to the stored reference output.

5. The monitoring device according to claim 1, wherein the at least one sensor associated with the point-of-sale terminal includes a camera in the point-of-sale terminal.

6. The monitoring device according to claim 1, wherein the at least one sensor associated with the point-of-sale terminal includes a scale integrated with the point-of-sale terminal.

7. The monitoring device according to claim 1, wherein
the at least one sensor includes a bagging area camera in the point-of-sale terminal and an operation area camera in the point-of-sale terminal,
the bagging area camera is positioned to image the bagging area, and
the operation area camera is positioned to image an operation area in front of the point-of-sale terminal.

8. The monitoring device according to claim 1, wherein the at least one sensor includes a camera separate from the point-of-sale terminal and positioned to image the bagging area and an operation area in front of the point-of-sale terminal.

9. The monitoring device according to claim 8, wherein the processor is further configured to extract a bagging area image and an operation area image from an image received from the camera.

10. The monitoring device according to claim 1, wherein the output device is a display screen of the point-of-sale terminal.

11. A point-of-sale terminal, comprising:
a bagging area;
a bagging area sensor;
an operation area sensor;
a data storage unit for storing a reference output of the bagging area sensor and a reference output of the operation area sensor;
an output device for providing information to a user at the point-of-sale terminal;
a communication interface for connecting to a monitoring terminal; and
a processor configured to:
receive sensor output from the bagging area sensor and the operation area sensor;
determine, based on the received sensor output from the bagging area sensor, whether merchandise is present in the bagging area after a registration of merchandise at the point-of-sale terminal;
determine, based on the received sensor output from the operation area sensor, whether there is a person at the point-of-sale terminal; and
cause the output device to output a warning when it is determined, based on the received sensor output, that the person is at the point-of-sale terminal during an on-going transaction at the point-of-sale but merchandise is no longer present in the bagging area after the registration of merchandise.

12. The point-of-sale terminal according to claim 11, wherein the processor is further configured to cause an alarm notification to the monitoring terminal via the communication interface when it is determined, based on the received sensor output, that the person is not at the point-of-sale terminal during an on-going transaction at the point-of-sale and merchandise is no longer present in the bagging area after the registration of merchandise.

13. The point-of-sale terminal according to claim 11, wherein
the processor determines whether merchandise is present in the bagging area by comparing the received sensor output from the bagging area sensor to the stored reference output for the bagging area sensor, and
the processor determines whether the person is at the point-of-sale terminal by comparing the received sensor output from the operation area sensor to the stored reference output for the operation area sensor.

14. The point-of-sale terminal according to claim 13, wherein
the bagging area sensor is a first camera, and
the operation area sensor is a second camera.

15. The point-of-sale terminal according to claim 13, wherein
the bagging area sensor is a scale, and
the operation area sensor is an infrared sensor.

16. The point-of-sale terminal according to claim 11, wherein
the bagging area sensor is one of a camera, a scale, and a distance sensor, and
the operation area sensor is one of a camera, an infrared sensor, and an ultrasonic sensor.

17. The point-of-sale terminal according to claim 11, further comprising:
a barcode scanner to read a barcode from an item of merchandise to register the item in a sales transaction at the point-of-sale terminal.

18. The point-of-sale terminal according to claim 17, wherein
the output device is a display screen, and
the warning is displayed on the display screen as a popup window over a registration screen being displayed on the display screen.

19. A method for a point-of-sale system, the method comprising:
receiving sensor output from at least one sensor associated with a point-of-sale terminal;
determining, based on the received sensor output, whether merchandise is present in a bagging area after a registration of merchandise at the point-of-sale terminal;
determining, based on the received sensor output, whether there is a person at the point-of-sale terminal; and
causing an output device to output a warning when it is determined, based on the received sensor output, that the person is at the point-of-sale terminal during an on-going transaction at the point-of-sale but merchandise is no longer present in the bagging area after the registration of merchandise, wherein
the warning is output to the person at the point-of-sale terminal.

20. The method according to claim 19, further comprising:
causing an alarm notification to be output via a communication interface to a monitoring terminal when it is determined, based on the received sensor output, that the person is not at the point-of-sale terminal during an on-going transaction at the point-of-sale and merchandise is no longer present in the bagging area after the registration of merchandise.
